(19) United States
(12) Patent Application Publication
(10) Pub. No.: US 2008/0301305 A1
(43) Pub. Date: Dec. 4, 2008

(54) METHOD AND RELATED SYSTEM FOR BUILDING UP A NETWORK CONNECTION BETWEEN CLIENTS AND SERVERS THROUGH A STREAM FORK BY UTILIZING HTTP PROTOCOL

(76) Inventor: Shih-Yung Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/856,053

(22) Filed: Sep. 16, 2007

(30) Foreign Application Priority Data
May 31, 2007 (TW) 096119512

(51) Int. Cl. G06F 15/16

(52) U.S. Cl. 709/228

(57) ABSTRACT

A method for building up a network connection between a client and a server through a stream fork by utilizing HTTP protocol includes receiving a connection request of the client, transmitting the connection request to the server, building up a connection channel between the client and the server and setting a channel ID of the client, and transmitting the channel ID to the client.

### BACKGROUND OF THE INVENTION

1. Field of the Invention

The present invention relates to a method and related system for building up a network connection between clients and servers through a stream fork, and more particularly, to a method and related system for building up the network connection between clients and servers through the stream fork by using HTTP protocol.

2. Description of the Prior Art

The dropping price of computers and network facilities has seen a substantial and continuing increase in the popularity of local area networks (LAN). A local area network can be easily installed in small areas, such as at the home or office, to allow more people to connect the computers within a particular range and share resources amongst each other. However, in order to prevent damage from exterior threats and malicious activity, firewalls are usually set up in the local area network to protect the computers inside the LAN. Although the firewalls can secure the internal network, network convenience is lessened. Hence, it is important to consider how to manage LAN security without affecting network convenience.

Please refer to FIG. 1. FIG. 1 is a diagram of a system 10 located on a network according to the prior art. The system includes a server 110, a first client 120, and a second client 130. The server 110, the first client 120, and the second client 130 connect to each other over the same local area network 150. For example, the local area network 150 can be an internal network of an enterprise institution, an educational campus, or an administrative unit. The server 110 is used for providing a variety of network services, such as printing data, sharing files, transmitting data, or providing network storage space. In general, the first client 120 and the second client 130 directly connect to the server 110 in the local area network via Transmission Control Protocol/Internet Protocol (TCP/IP) protocol to use the variety of network services provided by the server 110.

Please refer to FIG. 2. FIG. 2 is a diagram showing the interactive manner between the first client 120 and the server 110 in FIG. 1. As shown in FIG. 2, the first client 120 first needs to transmit a connection request to the server 110. At this time, in TCP/IP networks, the first client 120 must know the IP address and port number of the server 110. The server 110 will determine whether to accept or reject the connection request from the first client 120 according to a rule. If the server 110 accepts the connection request from the first client 120, then the first client transmits a request or an order. The practical content of the request or order is related to the network services provided by server 110; for example, the first client 120 sends out a request or order to ‘download a file’, ‘delete a file’, ‘add a catalog’, or ‘print data’. Finally, after the server 110 processes the request (or the order), the data and the result are returned to the first client 120 and a response is transmitted to the first client.

Generally speaking, most miscellaneous network services used in offices by users can be described through the abovementioned client/server model. However, if the users leave the office, the users can connect to the Internet from other locations, but are unable to easily use those network services provided at the office. Please refer to FIG. 3. FIG. 3 is a diagram of a system 30 located on the network according to the prior art. The system 30 includes a server 310, a first client 320, a second client 330, and a firewall 340. The server 310 and the second client 330 connect to each other over the same local area network 350, and the client 320 is located on an Internet 380 outside the local area network 350. The firewall 340 is located between the local area network 350 and the Internet 380 for separating the computers on the Internet 380 (such as the first client 320) from arbitrarily contacting the computers inside the local area network 350 (such as the server 310 and the second client 330). Therefore, the first client 320 is unable to connect to the computers inside the local area network 350 through the Internet 380. Although the firewall 340 can protect its internal network security, network convenience is lessened.

In local area networks, the manner for using the network services is directly connecting to the server using the TCP/IP protocol. In order to separate the computers on the Internet (such as the first client 320) from arbitrarily contacting the computers inside a local area network (such as the server 310 and the second client 330), the enterprise usually sets up the firewall to protect the computers inside the local area network. Most of the computers or network facilities inside the local area network, however, use virtual IP addresses and connect to the Internet through network address translation (NAT) apparatuses. But the computers on the Internet are unable to connect to the computers inside the local area network. Hence, when the users are at home or are away, they can connect to the Internet but are unable to use the network services provided in the office easily. In order to allow the computers on the Internet to use the network services inside the local area network or to connect to the computers inside the local area network, technologies such as virtual private network (VPN) or port mapper can be adopted. But the involved facilities and configurations are extremely complicated and not cost-economical.

### SUMMARY OF THE INVENTION

The claimed invention provides a method for building up a network connection between a client and a server through a stream fork by utilizing HTTP protocol. The method includes receiving a connection request of the client, transmitting the connection request to the server, building a connection channel between the client and the server and setting a channel ID for the client, and transmitting the channel ID to the client. The method further includes receiving a request for building a writing channel transmitted by the client and transmitting a request for building a reading channel to the stream fork. The connection request of the client is a Hyper Text Transport Protocol (HTTP) request of the client.

The claimed invention provides a system for connecting to a local area network (LAN) through the Internet by utilizing HTTP protocol. The system includes a client, a server, and a stream fork. The server is used for providing services for transmitting data. The stream fork is capable of connecting to the client through an Internet and is capable of connecting to the server through the LAN. The server and the stream fork connect to each other through the LAN and the client connects to the stream fork through the Internet. When the client connects to the stream fork through HTTP protocol and transmits a connection request, the stream fork utilizes TCP protocol to respectively connect to the client and to the server and transmits a channel ID to the client. The client is further used for transmitting a HTTP request to the stream fork, and the stream fork is further used for transmitting a TCP connection request to the server. The client is further used for transmitting a request for building up a writing channel to the stream fork and transmitting a request for building up a reading channel to the stream fork.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a system located on a network according to the prior art.

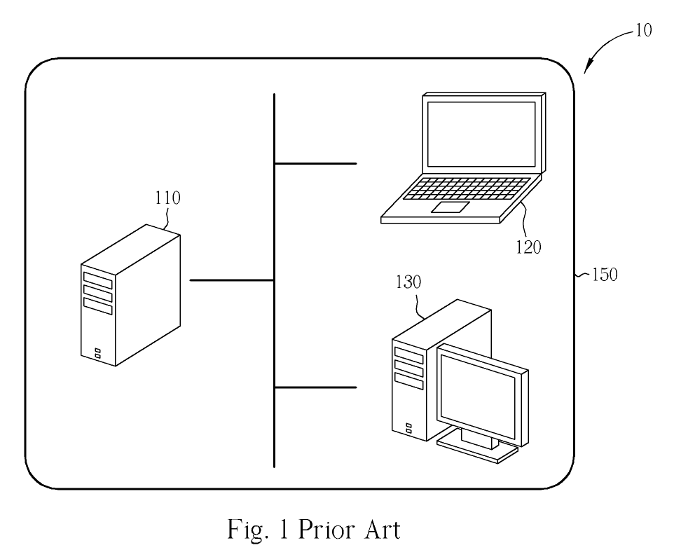

FIG. 2 is a diagram showing the interactive manner between the first client and the server in FIG. 1.

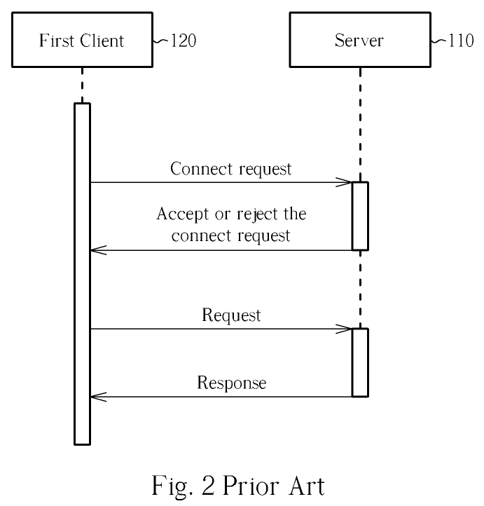

FIG. 3 is a diagram of a system located on the network according to the prior art.

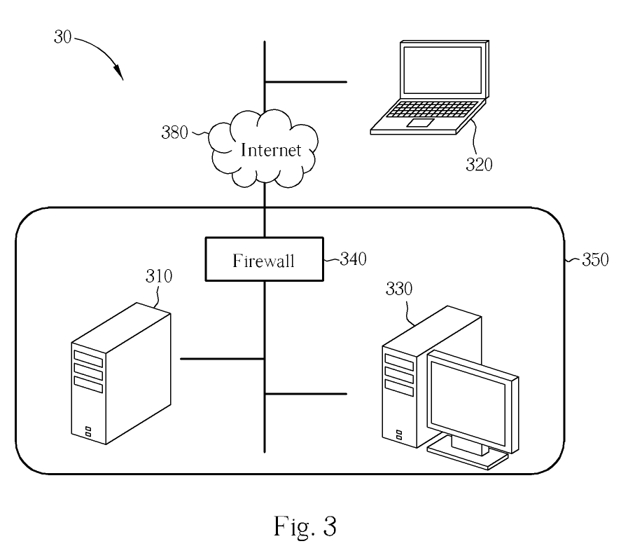

FIG. 4 is a diagram of a system located on a network according to an embodiment of the present invention.

FIG. 5 is a diagram showing the interactive manner between the first client, the stream fork, and the server in FIG. 4.

FIG. 6 is a flowchart showing a method for building up a network connection between a client and a server through a stream fork by utilizing HTTP protocol according to an embodiment of the present invention.

### DETAILED DESCRIPTION

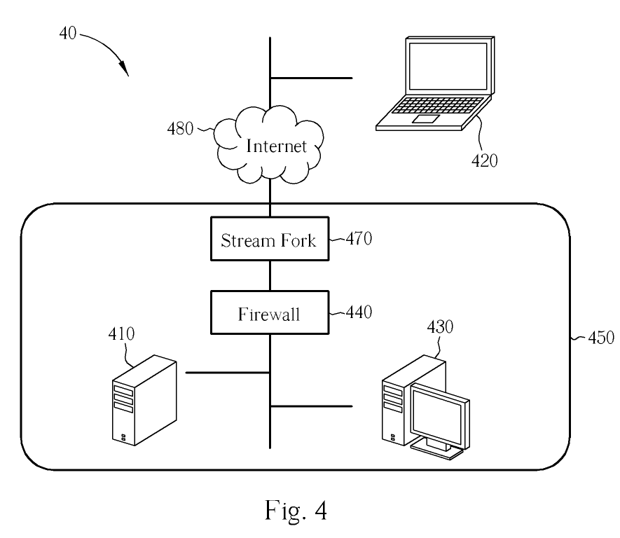

Please refer to FIG. 4. FIG. 4 is a diagram of a system 40 located on a network according to an embodiment of the present invention. The system 40 includes a server 410, a first client 420, a second client 430, a firewall 440, and a stream fork 470. The server 410, the second client 430, and the stream fork 470 connect to each other through the same local area network 450, and the first client 420 is located on an Internet 480 outside the local area network 450. The firewall 440 is located between the local area network 450 and the Internet 480 for separating the computers on the Internet 480 (such as the first client 420) from arbitrarily contacting the computers inside the local area network 450 (such as the server 410 and the second client 430). The first client 420 can connect to the stream fork 470through the Internet 480, and the stream fork 470 can connect to the server 410 through the local area network 450. Please note that, the server 410 and the stream fork 470 are connected through the local area network 450, and the first client 420 can connect to the stream fork 470 only through the Internet 480. When the first client 470 connects to the stream fork 470 and sends out a connection request through HTTP protocol, the stream fork 470 utilizes TCP protocol to respectively connect to the first client 420 and the server 410 and transmits a channel ID to the first client 420.

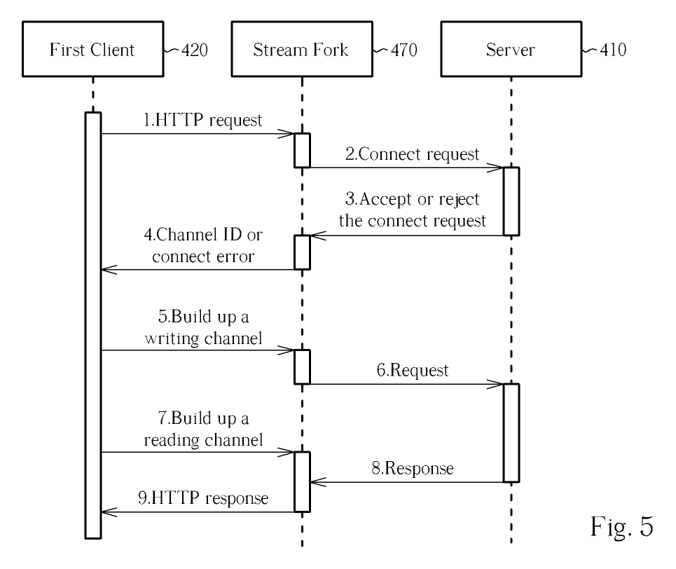

The operational manner for the abovementioned first client 420, the stream fork 470, and the server 410 is explained in FIG. 5. The first client 420 is further used for sending out a Hyper Text Transport Protocol (HTTP) request to the stream fork 470 and is able to connect to the stream fork 470 through the Internet 480. After the stream fork 470 receives the HTTP request, the stream fork 470 is further used for transmitting a Transmission Control Protocol (TCP) connect request to the server 410. The stream fork 470 can connect to the server 410 through the local area network 450. After that, the first client 420 is further used for sending out a request for building up a writing channel to the stream fork 470 and for sending out a request for building up a reading channel to the stream fork 470 in order to build up two TCP connections. Finally, the stream fork 470 is further used for transmitting the request for building up the writing channel sent by the first client 420 to the server 410, and the server 410 is further used for sending out a response to the stream fork 470. The stream fork 470 is further used for transmitting a HTTP response to the first client 420.

In the abovementioned embodiment, the local area network 450 can be an internal network of an enterprise institution, an educational campus, or an administrative unit, but is not limited to this and can be other local area networks. The server 410 is used for providing a variety of network services, such as printing data, sharing files, transmitting data, or providing network storage space, but is also not restricted to this and can provide other network services.

Please refer to FIG. 5. FIG. 5 is a diagram showing the interactive manner between the first client 420, the stream fork 470, and the server 410 in FIG. 4. As shown in FIG. 5, the first client 420 first sends out a HTTP connect request to the stream fork 470 (an HTTP GET command or an HTTP POST command, for example) whereof the IP address and port number of the server must be assigned. Please note that functions and applications for HTTP commands are technologies that are well-known by those skilled in the art, and are therefore not described in detail herein. The stream fork 470 will transmit a connect request to the server 410 according to the IP address and the port number provided by the first client 420. At this time, the client 410 will determine whether to accept or reject the connect request sent by the stream fork 470 according to a predetermined rule. After the server 410 accepts the connect request, the stream fork 470 will build up a connection channel between the first client 420 and the server 410 and set up a channel ID of the first client 420. The first client 420 must record the channel ID and use the HTTP POST command to transmit a request for building up a writing channel to the stream fork 470 in an independent TCP connection. Please note that all requests sent by the first client 420 afterwards are transmitted via TCP connection. When the first client 420 sends out the request for building up the writing channel to the stream fork 470, the stream fork 470 will readily transmit the request for building up the writing channel sent by the first client 420 to the server 410. After that, the first client 420 uses the HTTP GET command to transmit a request for building up a reading channel in another independent TCP connection. When the stream fork 470 transmits the request for building up the reading channel sent by the first client 420 to the server 410, the server 410 will transmit the processed data and result to the stream fork 470 and send out a response to the stream fork 470. Finally, the stream fork 470 uses the HTTP response to transmit the response sent by the server 410 to the first client 420 in the TCP connection of reading channel. Please note that, all the responses of the server 410 afterwards are transmitted to the first client 420 via the TCP connection.

In the abovementioned embodiment, the HTTP connect request can be the HTTP GET command or the HTTP POST command or other HTTP commands. Please note that there are completely two independent TCP connections in this example, whereof the first TCP connection is used for building up the writing channel and for transmitting all requests sent by the first client 420 to the stream fork 470, and the second TCP connection is used for building up the reading channel and for transmitting all responses of the server 410 to the first client 420. Through the method of the present invention, no matter where the first client 420 is located, the HTTP protocol can be used for easily connecting to the stream fork 470 and then connecting to the computers inside the local area network 450 (such as the server 410 or the second client 430).

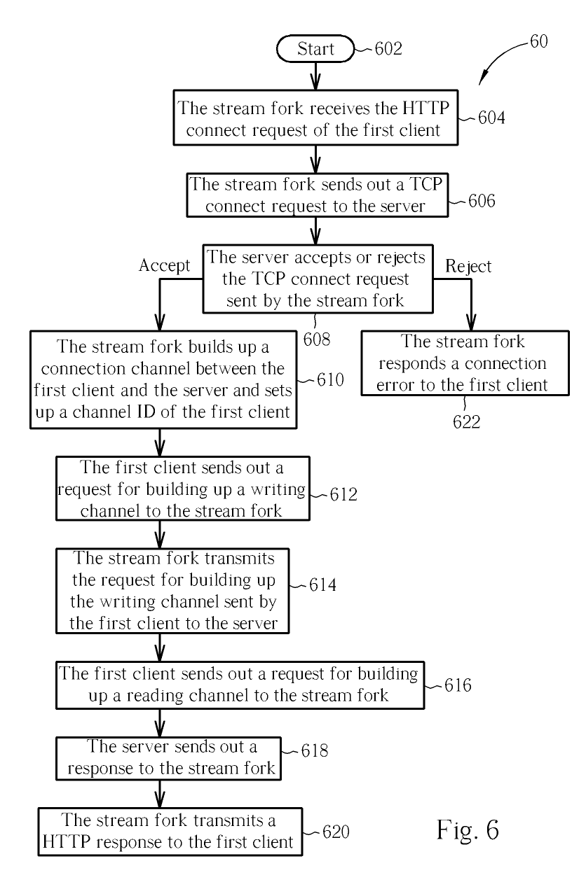

Please refer to FIG. 6. FIG. 6 is a flowchart of a process 60 showing a method for building up a network connection between a client and a server through a stream fork by utilizing HTTP protocol according to an embodiment of the present invention. The process 60 includes, but is not limited to, the following steps:

Step 602: Process start.

Step 604: The stream fork 470 receives the HTTP connect request from the first client 410.

Step 606: The stream fork 470 sends a TCP connect request to the server 410.

Step 608: The server 410 accepts or rejects the TCP connect request sent by the stream fork 470. If the server 410 accepts the TCP connect request sent by the stream fork 470, then step 610 is executed; otherwise, the step 622 is executed.

Step 610: The stream fork 470 builds up a connection channel between the first client 420 and the server 410 and sets up a channel ID of the first client 420.

Step 612: The first client 420 sends out a request for building up a writing channel to the stream fork 470.

Step 614: The stream fork 470 transmits the request for building up the writing channel sent by the first client 420 to the server 410.

Step 616: The first client 420 sends out a request for building up a reading channel to the stream fork 470.

Step 618: The server 410 sends out a response to the stream fork 470.

Step 620: The stream fork 470 transmits an HTTP response to the first client 420.

Step 622: The stream fork 470 responds with a connection error to the first client 420.

Please refer to FIG. 5 and FIG. 6 together. First of all, the stream fork 470 receives the HTTP connect request of the first client 410 (step 604). Then the stream fork 470 sends out the TCP connect request to the server 410 according to the HTTP connect request of the first client 420 (step 606), and the server 410 accepts or rejects the TCP connect request sent by the stream fork 470 (step 608). At this point, the process is divided into two parts for illustration: when the server 410 accepts the TCP connect request sent by the stream fork 470, steps 610-620 are executed; when the server 410 rejects the TCP connect request sent by the stream fork 470, only step 622 is executed. If the server 410 accepts the TCP connect request sent by the stream fork 470, the stream fork 470 will build up the connection channel between the first client 420 and the server 410 and set up the channel ID of the first client 420 (step 610). The first client 420 must record the channel ID and sends out the request for building up the writing channel (step 612) and the request for building up the reading channel (step 616) to the stream fork 470 via two independent TCP connections. In step 614, the stream fork 470 readily transmits the request for building up the writing channel sent by the first client 420 to the server 410. In the steps 618-620, the server 410 will transmit the processed data and result to the stream fork 470 and send the response to the stream fork 470, and the stream fork 470 will transmit the HTTP response to the first client 420. On the other hand, if the server 410 instead rejects the TCP connect request sent by the stream fork 470, the stream fork 470 will respond with a connection error to the first client 420 (step 622).

Please note that, when transmitting the channel ID to the first client 420, the HTTP response for completing building up the connection channel and the channel ID are transmitted to the client simultaneously.

In the abovementioned embodiments, because the server 410 and the stream fork 470 connect to each other through the same local area network 450, so the stream fork 470 can utilize TCP/IP protocol to directly connect to the server 410. On the other hand, although the first client 420 is located on the Internet 480 outside the local area network 450, the first client 420 can connect to the stream fork 470 through the Internet 480 only. The first client 420 uses HTTP protocol to connect to the stream fork 470, and most firewalls permit the HTTP protocol. Therefore, not too many extra configurations are needed for easily connecting to the computers inside the local area network 450 (such as the server 410).

The abovementioned embodiments are presented merely for describing the present invention, and in no way should be considered to be limitations of the scope of the present invention. The local area network 450 can be an internal network of an enterprise institution, an educational campus, or an administrative unit, and is not limited to this only and can be other local area networks. The first client 410 and the second client 430 are merely used for illustrating the present invention, and the number of clients is not restricted to two only and can be expanded to a plurality, depending on practical applications. Furthermore, the present invention adopts two independent TCP connections (for the writing channel and for the reading channel), which are respectively used for transmitting all the requests from the first client 420 to the stream fork 470 and for transmitting all the responses from the server 410 to the first client 420. Please note that, the process 60 is merely a preferred embodiment of the present invention and should not be a limitation of the present invention, whereof the sequence of the steps can be modified depending on different conditions.

In summary, the present invention provides a method and related system for building up a network connection between clients and servers through a stream fork by utilizing the HTTP protocol. Because the first client 420 located on the Internet 480 utilizes the HTTP protocol to connect to the stream fork 470, most of the firewalls will permit the connection over HTTP protocol. Therefore, not too many extra configurations are necessary to easily connect to computers inside the local area network 450 (such as the server 410). No matter where the first client 420 is located, the HTTP protocol can be used for easily connecting to the stream fork 470 and then connecting to the computers inside the local area network 450 (such as the server 410 or the second client 430). As for the applications of the present invention, the modifications of the first client 420 are not complicated, whereof only programs for building up the TCP connection are altered and some simple HTTP headers are added. There is no need to alter the server 410. It is not only easy and convenient in use but also no extra cost is spent. Therefore, if the users are at home or are away from the office, they can connect to the Internet and are able to use to network services provided in the office easily.

Those skilled in the art will readily observe that numerous modifications and alterations of the device and method may be made while retaining the teachings of the invention.

What is claimed is:

1. A method for building up a network connection between a client and a server, the method comprising:
receiving a connection request of the client;
transmitting the connection request to the server;
building up a connection channel between the client and the server and setting a channel ID of the client; and
transmitting the channel ID to the client.

2. The method of claim 1 further comprising:
when transmitting the channel ID to the client, simultaneously transmitting an HTTP response for completing building up the connection channel and the channel ID to the client.

3. The method of claim 1 further comprising:
receiving a request for building up a writing channel transmitted by the client; and transmitting a request for building up a reading channel to the stream fork.

4. The method of claim 1, wherein the step of receiving the connection request of the client comprises receiving a Hyper Text Transport Protocol (HTTP) request of the client.

5. The method of claim 1 further comprising:
transmitting a Transmission Control Protocol (TCP) connection request to the server; and
receiving an acceptance or a rejection of the TCP connection request of the server.

6. The method of claim 5 further comprising:
responding with a connection error to the client when receiving the rejection of the TCP connection request of the server.

7. A system for connecting to a Local Area Network (LAN) through an Internet by utilizing Hyper Text Transport Protocol (HTTP), the system comprising:
a client;
a server utilized for providing services for transmitting data; and
a stream fork, for connecting to the client through the Internet and for connecting to the server through the LAN;
wherein the server and the stream fork connect to each other through the LAN, and the client connects to the stream fork through the Internet;
wherein the stream fork utilizes Transmission Control Protocol (TCP) protocol to respectively connect to the client and to the server and transmits a channel ID to the client when the client connects to the stream fork through HTTP protocol and transmits a connection request.

8. The system of claim 7, wherein:
the client is further used for transmitting an HTTP request to the stream fork; and
the stream fork is further used for transmitting a TCP connection request to the server.

9. The system of claim 7, wherein the client is further used for:
transmitting a request for building up a writing channel to the stream fork; and
transmitting a request for building up a reading channel to the stream fork.

10. The system of claim 9, wherein:
the stream fork is further used for transmitting to the server the request for building up the writing channel transmitted from the client; and
the server is further used for transmitting a response to the stream fork.

11. The system of claim 9, wherein the stream fork is further used for transmitting an HTTP response to the client.
